(19) United States
(12) Patent Application Publication
(10) Pub. No.: US 2011/0223383 A1
(43) Pub. Date: Sep. 15, 2011

(54) SEMI-CURED BODY, CURED BODY, MULTILAYER BODY, METHOD FOR PRODUCING SEMI-CURED BODY, AND METHOD FOR PRODUCING CURED BODY

(75) Inventors: Nobuhiro Goto, Tsukuba-shi (JP); Masaru Heishi, Adachi-ku (JP); Junnosuke Murakami, Ibaraki (JP)

(73) Assignee: SEKISUI CHEMICAL CO., LTD., Osaka (JP)

(21) Appl. No.: 13/119,017

(22) PCT Filed: Sep. 18, 2009
(86) PCT No.: PCT/JP2009/004740

§ 371 Date: May 26, 2011

(30) Foreign Application Priority Data
Sep. 24, 2008 (JP) 2008-244554

(51) Int. Cl. B32B 15/092; B32B 3/00; C08J 3/20; C08K 3/36; C08L 63/00

(52) U.S. Cl. 428/141; 523/466; 428/418

(57) ABSTRACT

Provided is: a semi-cured body capable of reducing the surface roughness of a roughening-treated surface, and, when a metal layer is formed on the surface of a cured body after curing, increasing the adhesive strength between the cured body and the metal layer; and a laminated body obtained by using the semi-cured body.

A semi-cured body 1 is formed by performing a roughening treatment on a reactant obtained by reacting a resin composition which includes an epoxy resin, a curing agent, and a silica component in which silica particles with a mean particle diameter equal to or less than 1 μm are surface treated with a sane coupling agent, such that the reactant has a gel fraction equal to or higher than 90% after being immersed in methyl ethyl ketone for 24 hours at 23° C. A laminated body comprises a cured body obtained by curing the semi-cured body 1, and a metal layer formed by having a plate processing performed on the surface of the cured body. The adhesive strength between the cured body and the metal layer is equal to or larger than 4.9/cm.

### TECHNICAL FIELD

The present invention relates to: a semi-cured body formed by reacting a resin composition which includes an epoxy resin, a curing agent, and a silica component to form a reactant, and by performing a roughening treatment on the reactant; a cured body and a laminated body obtained by using the semi-cured body; a method for producing the semi-cured body; and a method for producing the cured body.

### BACKGROUND ART

Conventionally, various thermosetting resin compositions are used to form multilayer substrates, semiconductor devices, or the like.

For example, patent literature 1 described below discloses an epoxy resin composition including a bisphenol A type epoxy resin, a modified phenol novolac type epoxy resin having a structure of phosphaphenanthrenes within the molecule, a phenol novolac curing agent having a triazine ring within the molecule, and an inorganic filler. In this disclosure, a resin insulation layer is formed by heating a prepreg, a resin film, or a resin varnish formed from the epoxy resin composition at 100° C. to 200° C. for 1 to 90 minutes, and then, a roughening treatment is performed on the surface of the resin insulation layer by using a roughening liquid.

### CITATION LIST

### Patent Literature

[PTL 1] Japanese Laid-Open Patent Publication No. 2008-074929

### SUMMARY OF THE INVENTION

### Problems to be Solved by the Invention

However, with patent literature 1, there are cases where the surface roughness of the surface of a resin insulation layer obtained by performing a roughening treatment is not sufficiently small. Furthermore, when a metal layer is formed on the surface of the resin insulation layer by plate processing, there are cases where the adhesive strength between the resin insulation layer and the metal layer is low.

An objective of the present invention is to provide: a semi-cured body capable of reducing the surface roughness of a roughening-treated surface, and, when a metal layer is formed on the surface of a cured body after curing, increasing the adhesive strength between the cured body and the metal layer; a cured body and a laminated body obtained by using the semi-cured body; a method for producing the semi-cured body; and a method for producing the cured body.

### Solution to the Problems

The present invention provides a semi-cured body formed by having a roughening treatment performed on a reactant obtained through a reaction of a resin composition which includes an epoxy resin, a curing agent, and a silica component in which silica particles with a mean particle diameter equal to or less than 1 μm are surface treated with a silane coupling agent. The reaction is performed on the resin composition such that the reactant has a gel fraction equal to or higher than 90% after being immersed in methyl ethyl ketone for 24 hours at 23° C.

In the present invention, the reaction of the resin composition is preferably performed so as to obtain a gel fraction equal to or higher than 95% after being immersed in methyl ethyl ketone for 24 hours at 23° C. In such case, the surface roughness of the surface of the semi-cured body obtained by having a roughening treatment performed can be further reduced.

In a specific aspect of the semi-cured body according to the present invention, a surface on which the roughening-treatment is performed has an arithmetic mean roughness Ra equal to or less than 0.3 μm and a ten-point mean roughness Rz equal to or less than 3.0 μm.

In another specific aspect of the semi-cured body according to the present invention, the epoxy resin is at least one type selected from the group consisting of epoxy resins having a naphthalene structure, epoxy resins having a dicyclopentadiene structure, epoxy resins having a biphenyl structure, epoxy resins having an anthracene structure, epoxy resins having a bisphenol-A structure, and epoxy resins having a bisphenol-F structure.

In still another specific aspect of the semi-cured body according to the present invention, the curing agent is at least one type selected from the group consisting of phenolic compounds having a naphthalene structure, phenolic compounds having a dicyclopentadiene structure, phenolic compounds having a biphenyl structure, phenolic compounds having an aminotriazine structure, active ester compounds, and cyanate resins.

In another specific aspect of the semi-cured body according to the present invention, the resin composition further includes an imidazole silane compound within a range from 0.01 to 3 parts by weight with regard to a total 100 parts by weight of the epoxy resin and the curing agent.

In still another specific aspect of the semi-cured body according to the present invention, the roughening treatment is performed on the reactant at 50° C. to 80° C. for 5 to 30 minutes.

In another specific aspect of the semi-cured body according to the present invention, a swelling treatment is performed on the reactant before the roughening treatment.

In still another specific aspect of the semi-cured body according to the present invention, the swelling treatment is performed on the reactant at 50° C. to 80° C. for 5 to 30 minutes.

A cured body according to the present invention is obtained by having the semi-cured body, which is formed in accordance with the present invention, cured.

In a specific aspect of the cured body according to the present invention, the cured body is obtained by having the semi-cured body cured at 130° C. to 200° C.

A laminated body according to the present invention comprises the cured body formed in accordance with the present invention, and a metal layer formed by having a plate processing performed on the surface of the cured body; wherein the adhesive strength between the cured body and the metal layer is equal to or higher than 4.9 N/cm.

A method for producing the semi-cured body according to the present invention comprises: a step of forming a reactant through a reaction of a resin composition which includes an epoxy resin, a curing agent, and a silica component in which silica particles with a mean particle diameter equal to or less than 1 μm are surface treated with a silane coupling agent, wherein the reaction is performed on the resin composition such that the reactant has a gel fraction equal to or higher than 90% after being immersed in methyl ethyl ketone for 24 hours at 23° C.; and a step of forming a semi-cured body by having a roughening treatment performed on the reactant.

In a specific aspect of the method for producing the semi-cured body according to the present invention, the method further comprises a step of performing a swelling treatment on the reactant before the roughening treatment.

A method for producing the cured body according to the present invention comprises a step of curing, at 130° C. to 200° C., the semi-cured body obtained by the method for producing the semi-cured body.

### Advantageous Effects of the Invention

A semi-cured body according to the present invention is formed by having a roughening treatment performed on a reactant obtained through a reaction of a resin composition which includes an epoxy resin, a curing agent, and a silica component in which silica particles with a mean particle diameter equal to or less than 1 μm are surface treated with a silane coupling agent, where the reaction is performed on the resin composition such that the reactant has a gel fraction equal to or higher than 90%. Therefore, the surface roughness of the surface of the semi-cured body obtained by having the roughening treatment performed can be reduced. Furthermore, when a metal layer such as a copper plating layer is formed on the surface of a cured body formed by having the semi-cured body cured, the adhesive strength between the cured body and the metal layer can be increased.

### BRIEF DESCRIPTION OF THE DRAWINGS

FIG. 1 is a partially-cut front sectional view which schematically shows a semi-cured body according to one embodiment of the present invention.

FIG. 2 is a partially-cut front sectional view showing one example of a laminated body obtained by forming a metal layer on the surface of a cured body.

### DESCRIPTION OF EMBODIMENTS

The inventors of the present application have discovered that the surface roughness of the surface of a semi-cured body obtained by performing a roughening treatment can be reduced, and that the adhesive strength between a cured body and a metal layer can be increased, by forming a semi-cured body by having a roughening treatment performed on a reactant obtained through a reaction of a resin composition which includes an epoxy resin, a curing agent, and a silica component obtained having a surface treatment performed using a silane coupling agent on silica particles with a mean particle diameter equal to or less than 1 μm, where the reaction is performed on the resin composition such that the reactant has a gel fraction equal to or higher than 90% after being immersed in methyl ethyl ketone for 24 hours at 23° C.; and have perfected the present invention.

The resin composition used for forming the semi-cured body according to the present invention includes an epoxy resin, a curing agent, and a silica component obtained by having a surface treatment performed using a silane coupling agent on a silica component with a mean particle diameter equal to or less than 1 μm.

The semi-cured body according to the present invention is formed by having a roughening treatment performed on a reactant obtained through a reaction of the above described specific resin composition, such that the reactant has a gel fraction equal to or higher than 90% after being immersed in methyl ethyl ketone for 24 hours at 23° C.

Characteristics of the present invention includes a usage of the above described specific resin composition, and performing a reaction on the resin composition so as to satisfy the above described specific gel fraction. By satisfying both of these requirements, the surface roughness of the surface of a roughening-treated semi-cured body can be reduced. For example, a semi-cured body with a roughening-treated surface having an arithmetic mean roughness Ra equal to or less than 0.3 μm and a ten-point mean roughness Rz equal to or less than 3.0 μm can be obtained. The reaction is preferably performed on the above described resin composition so as to obtain a gel fraction equal to or higher than 95%. In such case, the surface roughness of the surface of the semi-cured body can be further reduced.

The reaction, which is performed on the resin composition so as to obtain a gel fraction 90% or higher, may be a heat curing reaction, a light curing reaction, or a reaction using another trigger, such as in the case with electron beam curing.

Specifically, the above described gel fraction is measured as follows.

A semi-cured body (reactant) obtained through a reaction of the resin composition is immersed in methyl ethyl ketone at 23° C. for 24 hours, and residue of the semi-cured body is taken out from methyl ethyl ketone by using a mesh. The residue taken out from methyl ethyl ketone is dried at 23° C. for 72 hours. Next, the weight of the residue after the drying is measured, and a gel fraction can be calculated by using the following formula (1).

Gel Fraction (%) W2/W1×100 Formula (1)

W1: Weight of the semi-cured body before being immersed in methyl ethyl ketone

W2: Weight of residue of the semi-cured body after drying

First, each component included in the resin composition will be described in the following.

(Epoxy Resin)

An epoxy resin included in the resin composition described above is an organic compound including at least one epoxy group (oxirane ring). The number of epoxy groups in a single molecule of the epoxy resin is equal to or more than one. The number of epoxy groups is preferably equal to or more than two.

A conventionally well-known epoxy resin can be used as the epoxy resin. With regard to the epoxy resin, a single type may be used by itself, or a combination of two or more types may be used. The epoxy resin also includes an epoxy resin derivative and a hydrogenated compound of an epoxy resin.

The epoxy resin includes, for example, an aromatic epoxy resin, an alicyclic epoxy resin, an aliphatic epoxy resin, a glycidyl ester type epoxy resin, a glycidyl amine type epoxy resin, a glycidyl acrylic type epoxy resin, a polyester type epoxy resin, or the like.

Furthermore, a flexible epoxy resin may be suitably used as the epoxy resin. Using the flexible epoxy resin can increase flexibility of the cured body.

The flexible epoxy resin includes: a diglycidyl ether of polyethylene glycol; a diglycidyl ether of polypropylene glycol; a poly glycidyl ether of a long chain polyol; a copolymer of glycidyl(meta)acrylate and a radical polymerizable monomer; a polyester resin including an epoxy group; a compound obtained by modifying, through epoxidation, a carbon-carbon double bond of a (co)polymer having a conjugated diene compound as a main body thereof; a compound obtained by modifying, through epoxidation, a carbon-carbon double bond of a partially hydrogenated compound of a (co)polymer having a conjugated diene compound as a main body thereof; a urethane modified epoxy resin; a polycaprolactone modified epoxy resin; or the like.

Furthermore, the flexible epoxy resin includes a dimer acid modified epoxy resin obtained by introducing an epoxy group within a molecule of a dimer acid or a derivative of a dimer acid, a rubber modified epoxy resin obtained by introducing an epoxy group within a molecule of a rubber ingredient, or the like.

The rubber ingredient includes NBR, CTBN, polybutadiene, acrylic rubber, or the like.

The flexible epoxy resin preferably has a butadiene backbone. By using the flexible epoxy resin having a butadiene backbone, flexibility of the cured body can be further increased. In addition, the rate of elongation of the cured body can be increased in a broad temperature range from a low temperature range to a high temperature range.

The epoxy resin is preferably at least one type selected from the group consisting of naphthalene type epoxy resins having a naphthalene structure, dicyclopentadiene type epoxy resins having a dicyclopentadiene structure, biphenyl type epoxy resins having a biphenyl structure, anthracene type epoxy resins having an anthracene structure, or bisphenol A type epoxy resins having a bisphenol-A structure, bisphenol F type epoxy resins having a bisphenol-F structure. In these cases, the surface roughness of the surface of the semi-cured body can be further reduced.

The biphenyl type epoxy resin is preferably a biphenyl type epoxy resin represented by the following formula (8). By using this preferable biphenyl type epoxy resin, the linear expansion coefficient of the cured body can be further reduced.

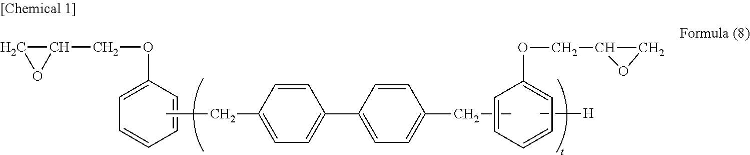

In the above described formula (8), t indicates an integer of 1 to 11.

The epoxy resin is preferably a naphthalene type epoxy resin, an anthracene type epoxy resin, or a dicyclopentadiene type epoxy resin. By using these preferable epoxy resins, the linear expansion coefficient of the cured body can be reduced. The epoxy resin is preferably an anthracene type epoxy resin, since the linear expansion coefficient of the cured body can be further reduced.

(Curing Agent)

There is no particular limitation in the curing agent as long as it can cure the epoxy resin. A conventionally well-known curing agent can be used as the curing agent.

The curing agent includes, for example, dicyanodiamide, an amine compound, a compound synthesized from an amine compound, a hydrazide compound, a melamine compound, an acid anhydride, a phenolic compound (phenol curing agent), an active ester compound, a benzoxazine compound, a maleimide compound, a heat latent cationic polymerization catalyst, a light latent cationic polymerization initiator, a cyanate resin, or the like. Derivatives of these curing agents may be used. With regard to the curing agent, a single type may be used by itself, or a combination of two or more types may be used. Furthermore, a curing catalyst such as acetylacetone iron may be used together with the curing agent.

The amine compound includes, for example, a linear aliphatic amine compound, a cyclic aliphatic amine compound, an aromatic amine compound, or the like.

The linear aliphatic amine compound includes, for example, ethylene diamine, diethylene triamine, triethylene tetramine, tetraethylene pentamine, polyoxypropylene diamine, polyoxypropylene triamine, or the like.

The cyclic aliphatic amine compound includes, for example, menthene diamine, isophorone diamine, bis(4-amino-3-methylcyclohexyl)methane, diaminodicyclohexylmethane, bis(aminomethyl)cyclohexane, N-aminoethyl piperazine, or the like.

The aromatic amine compound includes, for example, m-xylene diamine, α-(m/p-aminophenyl)ethylamine, m-phenylene diamine, diaminodiphenylmethane, α,α-bis(4-aminophenyl)-p-diisopropylbenzene, or the like.

A tertiary amine compound can be used as the amine compound. The tertiary amine compound includes, for example, N,N-dimethylpiperazine, pyridine, picoline, benzyldimethylamine, 2-(dimethylamino methyl) phenol, 2,4,6-tris(dimethylamino methyl)phenol, or the like.

Specific examples of the compound synthesized from the amine compound include a polyamino-amide compound, a polyamino-imide compound, a ketimine compound, or the like.

The polyamino-amide compound includes, for example, a compound synthesized from the amine compound and a carboxylic acid, or the like. The carboxylic acid includes, for example, succinic acid, adipic acid, isophthalic acid, terephthalic acid, dihydroisophthalic acid, tetrahydroisophthalic acid, hexahydroisophthalic acid, or the like.

The polyamino-imide compound includes, for example, a compound synthesized from the amine compound and a maleimide compound, or the like. The maleimide compound includes, for example, diaminodiphenylmethane bismaleimide or the like.

Other specific examples of the compound synthesized from the amine compound include a compound synthesized from the amine compound, and an epoxy compound, a urea compound, a thiourea compound, an aldehyde compound, a phenolic compound, an acrylic compound, or the like.

The hydrazide compound includes, for example, 1,3-bis(hydrazinocarboethyl)-5-isopropylhydantoin, 7,11-octadecadiene-1,18-dicarbohydrazide, eicosanedioic acid dihydrazide, adipic acid dihydrazide, or the like,

The melamine compound includes, for example, 2,4-diamino-6-vinyl-1,3,5-triazine, or the like.

The acid anhydride includes, for example, phthalic anhydride, trimellitic anhydride, pyromellitic anhydride, benzophenone tetracarboxylic anhydride, methyl tetrahydrophthalic anhydride, tetrahydrophthalic anhydride, trialkyl tetrahydrophthalic anhydride, hexahydrophthalic anhydride, methyl hexahydrophthalic anhydride, or the like.

The phenolic compound includes, for example, a phenol novolac, an o-cresol novolac, a p-cresol novolac, a t-butyl phenol novolac, dicyclopentadiene cresol, a phenol aralkyl resin, an α-naphthol aralkyl resin, a β-naphthol aralkyl resin, an amino triazine novolac resin, or the like. Derivatives of these may be used as the phenolic compound. With regard to the phenolic compound, a single type may be used by itself, or a combination of two or more types may be used.

The phenolic compound may be suitably used as the curing agent. By using the phenolic compound, the heat resistance and the dimensional stability of the cured body can be increased, and water absorptivity of the cured body can be reduced. Furthermore, the surface roughness of the surface of the semi-cured body can be further reduced. Specifically, the arithmetic mean roughness Ra and the ten-point mean roughness Rz of the surface of the semi-cured body can be further reduced.

A phenolic compound represented by any one of the following formula (1), formula (2), or formula (3) is more suitably used as the curing agent. In this case, the surface roughness of the surface of the semi-cured body can be further reduced.

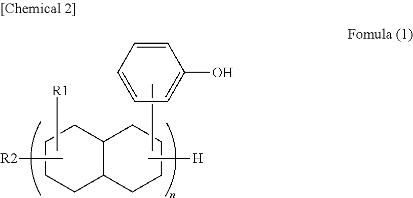

In the above described formula (1), R1 represents a methyl group or an ethyl group, R2 represents a hydrogen or a hydrocarbon group, and n represents an integer of 2 to 4.

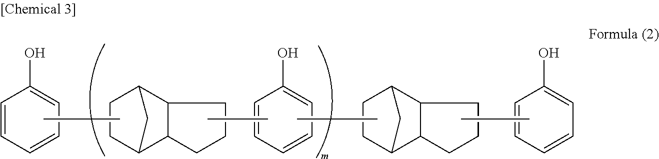

In the above described formula (2), m represents an integer of 0 to 5.

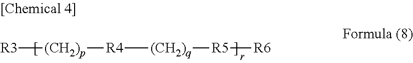

In the above described formula (3), R3 indicates a group represented by the following formula (4a) or formula (4b), R4 indicates a group represented by the following formula (5a), formula (5b), or formula (5c), R5 indicates a group represented by the following formula (6a) or formula (6b), R6 indicates a hydrogen or an organic group having a carbon number of 1 to 20, p represents an integer of 1 to 6, q represents an integer of 1 to 6, and r represents an integer of 1 to 11.

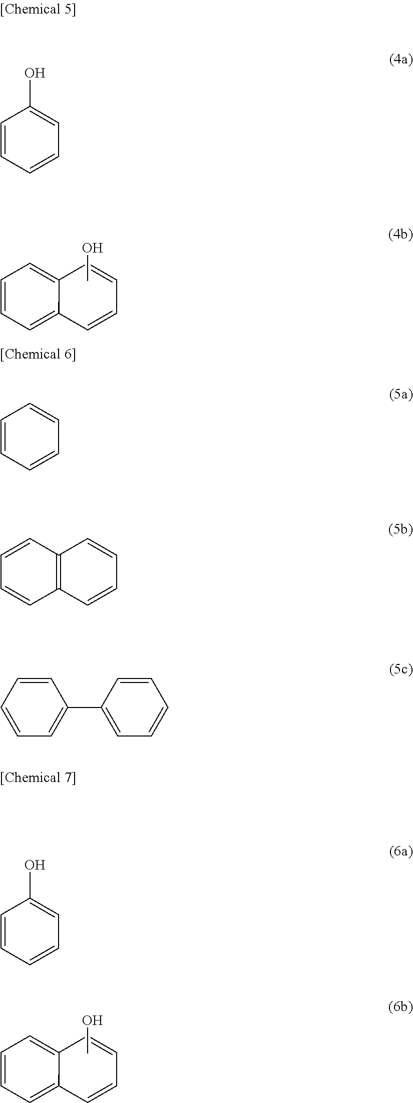

Among those, the phenolic compound having a biphenyl structure, which is a phenolic compound represent by the formula (3), and in which R4 in the formula (3) is a group represented by the formula (5c), is preferable. By using this preferable curing agent, the electrical property and the heat resistance of the cured body can be further increased. Furthermore, in case a thermal history is to be given to the cured body, the dimensional stability thereof can be further increased.

A phenolic compound having the structure shown in the following formula (7) is particularly preferable as the curing agent. In this case, the electrical property and the heat resistance of the cured body can be further increased. Furthermore, in case a thermal history is to be given to the cured body, the dimensional stability thereof can be further increased.

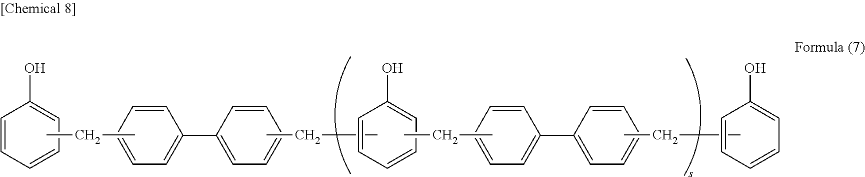

In the above described formula (7), s represents an integer of 1 to 11.

The active ester compound includes, for example, an aromatic multivalent ester compound or the like. By using the active ester compound, a cured body having excellent dielectric constant and dielectric loss tangent can be obtained. A specific example of the active ester compound is disclosed in, for example, Japanese Laid-Open Patent Publication No, 2002-12650.

Commercial items of the active ester compound include, for example, “EPICLON EXB9451-65T” and “EPICLON EXB94605-65T”, which are product names and which are manufactured by DIC Corp., and the like.

For example, a novolac type cyanate ester resin, a bisphenol type cyanate ester resin, a prepolymer having one part thereof modified to have a triazine structure, and the like can be used as the cyanate ester resin. By using the cyanate ester resin, the linear expansion coefficient of the cured body can be further reduced.

The maleimide compound is preferably at least one type selected from the group consisting of N,N′-4,4-diphenylmethane bismaleimide, N,N′-1,3-phenylene dimaleimide, N,N′-1,4-phenylene dimaleimide, 1,2-bis(maleimide)ethane, 1,6-bismaleimide hexane, bis(3-ethyl-5-methyl-4-maleimide phenyl)methane, polyphenylmethane maleimde, bisphenol A diphenyl ether bismaleimide, 4-methyl-1,3-phenylene bismaleimide, 1,6-bismaleimide-(2,2,4-trimethyl)hexane, oligomers of these, and maleimide-backbone-containing diamine condensates. By using these preferable maleimide compounds, the linear expansion coefficient of the cured body can be further reduced, and the glass transition temperature of the cured body can be further increased. The above described oligomer is an oligomer obtained by condensating a maleimide compound which is a monomer among the above described maleimide compounds.

Among those, the maleimide compound is more preferably at least one of polyphenylmethane maleimide or a bismaleimide oligomer. The bismaleimide oligomer is preferably an oligomer obtained by condensating phenylmethane bismaleimide and 4,4-diaminodiphenylmethane. By using these preferably maleimide compounds, the linear expansion coefficient of the cured body can be further reduced, and the glass transition temperature of the cured body can be further increased.

Commercial items of the maleimide compound include polyphenylmethane maleimide (product name “BMI-2300” manufactured by Daiwa Fine Chemicals Co., Ltd.), a bismaleimide oligomer (product name “DAIMAID-100H” manufactured by Daiwa Fine Chemicals Co., Ltd.), and the like.

The curing agent is preferably at least one type selected from the group consisting of phenolic compounds, active ester compounds, and cyanate resins. The curing agent is preferably a phenolic compound or an active ester compound. In cases where these preferable curing agents are used, when a roughening treatment is performed on the reactant, the resin component is unlikely to be subjected to adverse influences due to the roughening treatment. The cyanate resin is preferably a cyanate ester resin.

When the active ester compound or the benzoxazine compound is used as the curing agent, and particularly when the active ester compound is used as the curing agent, a cured body having even better dielectric constant and dielectric loss tangent can be obtained. The active ester compound is preferably an aromatic multivalent ester compound. By using the aromatic multivalent ester compound, a cured body having even better dielectric constant and dielectric loss tangent can be obtained.

It is particularly preferable if the curing agent is at least one type selected from the group consisting of phenolic compounds having a naphthalene structure, phenolic compounds having a dicyclopentadiene sir cloture, phenolic compounds having a biphenyl structure, phenolic compounds having an aminotriazine structure, active ester compounds, and cyanate resins. By using these preferable curing agents, when a roughening treatment is performed on the reactant, the resin component is even more unlikely to be subjected to adverse influences due to the roughening treatment. Specifically, during a roughening treatment, fine holes can be formed by selectively eliminating the silica component without excessively roughening the surface of the reactant. Thus, fine concavities and convexities with a very small surface roughness can be formed on the surface of the semi-cured body. Among the above, the phenolic compounds having a biphenyl structure are preferable.

When a phenolic compound having a biphenyl structure or a phenolic compound having a naphthalene structure is used, a cured body having superior electrical property, in particular, having a superior dielectric loss tangent, and also having a superior strength and linear expansion coefficient, and additionally having a low water absorption rate, can be obtained.

If the molecular weights of the epoxy resin and the curing agent are high, it becomes easy to form a fine rough-surface on the surface of the semi-cured body. The weight average molecular weight of the epoxy resin can influence the formation of a fine rough-surface. However, the weight average molecular weight of the curing agent can have a larger influence on the formation of a fine rough-surface than the weight average molecular weight of the epoxy resin. The weight average molecular weight of the curing agent is preferably equal to or larger than 500, and more preferably equal to or larger than 1800. A preferable upper limit of the weight average molecular weight of the curing agent is 15000.

If the epoxy equivalent of the epoxy resin and the equivalent amount of the curing agent are large, it becomes easy to form a fine rough-surface on the surface of the semi-cured body. Furthermore, it becomes easy to form a fine rough-surface on the surface of the semi-cured body if the curing agent is a solid, and if the softening temperature of the curing agent is equal or higher than 60° C.

The contained amount of the curing agent is preferably within a range from 1 to 200 parts by weight with regard to 100 parts by weight of the epoxy resin. If the contained amount of the curing agent is too low, the resin composition may not be cured sufficiently. If the contained amount of the curing agent is too high, the effect of curing the epoxy resin may reach saturation. With regard to the contained amount of the curing agent, a preferable lower limit is 30 parts by weight, and a preferable upper limit is 140 parts by weight.

(Curing Accelerator)

The resin composition preferably includes a curing accelerator. In the present invention, the curing accelerator is an optional component. There is no particular limitation in the curing accelerator.

The curing accelerator is preferably an imidazole curing accelerator. The imidazole curing accelerator is preferably at least one type selected from the group consisting of 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2,4-diamino-6-[2′-methyl imidazolyl-(1′)]ethyl-s-triazine, 2,4-diamino-6-[2′-undecyl imidazolyl-(1′)]-ethyl-s-triazine, 2,4-diamino-6-[2′-ethyl-4′-methyl imidazolyl-(1′)]-ethyl-s-triazine, adducts of 2,4-diamino-6-[2′-methyl imidazolyl-(1′)]-ethyl-s-triazine isocyanuric acid, adducts of 2-phenyl imidazole isocyanuric acid, adducts of 2-methyl imidazole isocyanuric acid, 2-phenyl-4,5-dihydroxymethylimidazole, and 2-phenyl-4methyl-5-dihydroxymethylimidazole.

Furthermore, the curing accelerator includes a phosphine compound such as triphenyl phosphine, diazabicycloundecene (DBU), diazabicyclononene (DBN), a phenol salt of DBU, a phenol salt of DBN, an octylic acid salt, a p-toluenesulfonic acid salt, a formate, an orthophthalate, a phenol novolac resin salt, or the like.

The contained amount of the curing accelerator is preferably within a range from 0.01 to 3 parts by weight with regard to 100 parts by weight of the epoxy resin. If the contained amount of the curing accelerator is too low, the resin composition may not be cured sufficiently.

In the present invention, the surface roughness of the surface of the semi-cured body can be reduced even if the curing accelerator is not added. However, when the curing accelerator is not added, there are cases where the Tg becomes low without a sufficient progress in the curing of the resin composition, and where the strength of the cured body fails to become sufficiently high.

If the contained amount of the curing accelerator is too high, the curing may become inhomogeneous when the resin composition is semi-cured or cured. Furthermore, preservation stability of the resin composition can become inferior. With regard to the contained amount of the curing accelerator, a preferable lower limit is 0.5 parts by weight, and a preferable upper limit is 2.0 parts by weight.

(Silica Component)

The resin composition includes a silica component obtained by performing a surface treatment on silica particles using a silane coupling agent. With regard to the silica component, a single type may be used by itself, or a combination of two or more types may be used.

The mean particle diameter of the silica particles is equal to or smaller than 1 μm. By having the mean particle diameter to be equal to or smaller than 1 μm, a fine rough-surface can be formed on the surface of the semi-cured body. Furthermore, fine holes having a size in which the mean diameter is equal to or smaller than 1 μm can be formed on the surface of the semi-cured body. The mean particle diameter of the silica particles is preferably equal to or larger 100 nm.

If the mean particle diameter of the silica particles is larger than 1 μm, it becomes difficult to eliminate the silica component when a roughening treatment is performed on the reactant. Furthermore, if plate processing is conducted in order to form a metal layer on the surface of the semi-cured body, the plating may slip into a void between the resin component and a silica component that has not been eliminated. Therefore, if the metal layer is formed as a circuit, a defect may occur in the circuit.

When a benzoxazine compound, an aromatic multivalent ester compound, or a phenolic compound, having a structure of any one of a naphthalene structure, a dicyclopentadiene structure, a biphenyl structure, and an aminotriazine structure, is used as the curing agent, it is difficult to remove the resin component from the periphery of the silica component by a roughening treatment. In this case, if the mean particle diameter of the silica particles is larger than 1 μm, a post-roughened peel strength becomes low since elimination of the silica component is more difficult.

With regard to the mean particle diameter of the silica particles, a value of median diameter (d50) representing 50% can be used. The mean particle diameter can be measured by using a particle-size-distribution measuring device utilizing laser diffraction dispersion method.

A plurality of types of silica particles having different mean particle diameters may be used. When considering close-packing, it is preferable to use the plurality of types of silica particles having different particle size distributions. In this case, the resin composition can be suitably used, for example, in a usage requiring fluidity such as for a parts-built-in substrate. Furthermore, apart from the silica component, by using silica particles having a mean particle diameter of several tens of nanometers, the viscosity of the resin composition can be increased and the thixotropism of the resin composition can be controlled.

The maximum particle diameter of the silica particles is preferably equal to or smaller than 5 μm. If the maximum particle diameter is equal to or smaller than 5 μm, the silica component can be more easily eliminated when a roughening treatment is performed on the reactant. Furthermore, a relatively large hole is unlikely to be generated on the surface of the semi-cured body, and thereby uniform and fine concavities and convexities can be formed.

When a benzoxazine compound, an aromatic multivalent ester compound, or a phenolic compound having a structure of any one of a naphthalene structure, a dicyclopentadiene structure, a biphenyl structure, and an aminotriazine structure, is used as the curing agent, it becomes difficult for a roughening liquid to penetrate into the reactant from the surface of the reactant, thus it becomes relatively difficult to eliminate the silica component. However, by using the silica component having a maximum particle diameter equal to or smaller than 5 μm, the silica component can be effortlessly eliminated. When forming fine wiring having an L/S equal to or less than 15 μm/15 μm on the surface of the semi-cured body, insulation reliability can be increased; and therefore, the maximum particle diameter of the silica is preferably equal to or smaller than 2 μm. Note that “L/S” represents: a wiring width direction dimension (L)/a dimension (S) in a width direction of a portion on which wirings are not formed.

There is no particular limitation in the shape of the silica particles. Examples of the shape of the silica particles include a spherical shape, an unfixed shape, or the like. It is preferable to have the silica particles to be spherical, and more preferable to be true-spherical, since the silica component can be more easily eliminated when a roughening treatment is performed on the reactant.

The specific surface area of the silica particles is preferably equal to or larger than 3 m²/g. If the specific surface area is smaller than 3 m²/g, the mechanical property of the cured body may deteriorate. Furthermore, adherence between the cured body and the metal layer may deteriorate. The specific surface area can be obtained from the BET method.

The silica particles includes, a crystalline silica obtained by grinding a natural silica material, a crushed-fused silica obtained by flame-fusing and grinding a natural silica material, a spherical fused silica obtained by flame-fusing, grinding, and then flame-fusing a natural silica material, a fumed silica (aerosil), a synthetic silica such as a sol-gel processed silica, or the like.

A fused silica is suitably used as the silica particles since purity thereof is high. The silica particles may be used as a silica slurry in a state of being dispersed in a solvent. The use of the silica slurry can increase workability and productivity during the production of the resin composition.

A conventionally well-known silane compound can be used as the silane coupling agent. The silane coupling agent is preferably at least one type selected from the group consisting of epoxy silanes, amino silanes, isocyanate silanes, acryloxy silanes, methacryloxy silanes, vinyl silanes, styryl silanes, ureido silanes, and sulfide silanes. Furthermore, a surface treatment of the silica particles may be conducted by using an alkoxy silane such as a silazane. With regard to the silane coupling agent, a single type may be used by itself, or a combination of two or more types may be used.

It is preferable to add the silica component to the resin composition after the silica component is obtained by surface-treating the silica particles by using the silane coupling agent. With this, the dispersibility of the silica component can be further increased.

A method for surface-treating the silica particles by using the silane coupling agent includes the following first to third methods, for example.

A dry method can be listed as the first method. The dry method includes, for example, a method of directly adhering the silane coupling agent to the silica particles, or the like. In the dry method, the silica particles are loaded in a mixer, and while agitating the silica particles, an alcohol solution or an aqueous solution of the silane coupling agent is dropped or sprayed therein. The mixture is further agitated and sorted using a sieve. Then, the silica component is obtained by dehydration condensation of the silane coupling agent and the silica particles through heating. The obtained silica component may be used as a silica slurry in a state of being dispersed in a solvent.

A wet method can be listed as the second method. In the wet method, the silane coupling agent is added to a silica slurry containing the silica particles while agitating the silica slurry. After agitating, the mixture is filtrated, dried, and sorted using a sieve. Then, the silica component is obtained by dehydration condensation of the silane compound and the silica particles through heating.

As the third method, a method of: adding the silane coupling agent while agitating a silica slurry containing the silica particles; and advancing dehydration condensation by heat reflux processing, can be listed. The obtained silica component may be used as a silica slurry in a state of being dispersed in a solvent.

If untreated silica particles are used and when the resin composition is cured, the silica particles and the epoxy resin will form a composite in a state of not being sufficiently compatible to each other. If a silica component obtained by having a surface treatment performed on the silica particles using a silane coupling agent is used, and when the resin composition is reacted, a composite will form in a state where the silica component and the epoxy resin being sufficiently compatible with each other at an interface of those. As a result, the strength and the heat resistance of the cured body can be increased. By including, in the resin composition, the silica component obtained by having a surface treatment performed on the silica particles using the silane coupling agent instead of the untreated silica particles, a further homogeneous resin composition can be obtained since dispersibility of the silica component can be increased. In addition, by increasing the dispersibility of the silica component, variation of the surface roughness of the surface of the semi-cured body can be reduced.

Furthermore, with a use of the silica component obtained by having a surface treatment performed on the silica particles using the silane coupling agent, reflow tolerance of the cured body can be increased. Additionally, water absorptivity of the cured body can be reduced and insulation reliability of the cured body can be increased.

The contained amount of the silica component is preferably within a range from 10 to 400 parts by weight with regard to a total 100 parts by weight of the epoxy resin and the curing agent. With regard to the contained amount of the silica component in a total 100 parts by weight of the epoxy resin and the curing agent, a more preferable lower limit is 25 parts by weight, and a further preferable lower limit is 43 parts by weight, and a more preferable upper limit is 250 parts by weight, and a further preferable upper limit is 150 parts by weight. If the contained amount of the silica component is too small, a total surface area of holes formed as a result of the elimination of the silica component during a roughening treatment of the reactant becomes small. Therefore, the adhesive strength between the cured body and the metal layer may not be sufficiently increased. If the contained amount of the silica component is too high, the cured body tends to be fragile, and the adhesive strength between the cured body and the metal layer may decrease.

(Other Components that can be Added)

The resin composition described above preferably includes an imidazole silane compound. By using the imidazole silane compound, the surface roughness of the surface of the roughening-treated cured body can be further reduced.

The imidazole silane compound is preferably included within a range from 0.01 to 3 parts by weight with regard to a total of 100 parts by weight of the epoxy resin and the curing agent. If the contained amount of the imidazole silane compound is within the above described range, the surface roughness of the surface of the roughening-treated cured body can be further reduced, and the post-roughened adhesive strength between the cured body and the metal layer can be further increased. A more preferable lower limit of the contained amount of the imidazole silane compound is 0.03 parts by weight, and a more preferable upper limit is 2 parts by weight, and an even more preferable upper limit is 1 part by weight. When the contained amount of the curing agent is larger than 30 parts by weight to 100 parts by weight of the epoxy resin, it is particularly preferable to include the imidazole silane compound within a range from 0.01 to 2 parts by weight with regard to a total of 100 parts by weight of the epoxy resin and the curing agent.

The above described resin composition may include an organically modified sheet silicate.

The organically modified sheet silicate includes, for example, organically modified sheet silicates obtained by organically modifying sheet silicates such as a smectite based clay mineral, a swelling mica, vermiculite, or halloysite. With regard to the organically modified sheet silicate, a single type may be used by itself, or a combination of two or more types may be used.

The smectite based clay mineral includes montmorillonite, hectorite, saponite, beidellite, stevensite, nontronite, or the like.

As the organically modified sheet silicate, an organically modified sheet silicate obtained by organically modifying at least one type of sheet silicate selected from the group consisting of montmorillonite, hectorite, and swelling mica may be suitably used.

The mean particle diameter of the organically modified sheet silicate is preferably equal to or smaller than 500 nm. When the mean particle diameter of the organically modified sheet silicate is equal to or smaller than 500 nm, the roughness of the roughening-treated surface can be further reduced. The mean particle diameter of the organically modified sheet silicate is preferably equal to or larger than 100 nm.

With regard to the mean particle diameter of the organically modified sheet silicate, a value of median diameter (d50) representing 50% can be used. The mean particle diameter can be measured by using a particle-size-distribution measuring device utilizing laser diffraction dispersion method.

The contained amount of the organically modified sheet silicate with regard to a total 100 parts by weight of the epoxy resin and the curing agent is preferably within a range from 0.01 to 3 parts by weight.

In addition to the epoxy resin, the resin composition may include a resin copolymerizable with the epoxy resin if necessary.

There is no particular limitation in the copolymerizable resin. The copolymerizable resin includes, for example, a phenoxy resin, a thermosetting modified-polyphenylene ether resin, a benzoxazine resin, or the like. With regard to the copolymerizable resin, a single type may be used by itself, or a combination of two or more types may be used.

Specific examples of the thermosetting modified-polyphenylene ether resin include resins or the like obtained by modifying a polyphenylene ether resin using functional groups such as epoxy group, isocyanate group, or amino group. With regard to the thermosetting modified-polyphenylene ether resin, a single type may be used by itself, or a combination of two or more types may be used.

Commercial items of the cured-type modified-polyphenylene ether resin obtained by modifying a polyphenylene ether resin using epoxy group include, for example, “OPE-2Gly”, which is a product name and which is manufactured by Mitsubishi Gas Chemical Co., Inc., or the like.

There is no particular limitation in the benzoxazine resin. Specific examples of the benzoxazine resin include: a resin in which a substituent group having a backbone of an aryl group such as methyl group, ethyl group, phenyl group, biphenyl group, or cyclohexyl group, is coupled to the nitrogen of an oxazine ring; a resin in which a substituent group having a backbone of an allylene group such as methylene group, ethylene group, phenylene group, biphenylene group, naphthalene group, or cyclohexylene group, is coupled in between the nitrogen atoms of two oxazine rings; or the like. With regard to the benzoxazine resin, a single type may be used by itself, or a combination of two or more types may be used. As a result of a reaction between the benzoxazine resin and the epoxy resin, the heat resistance of the cured body can be enhanced, and water absorptivity and the linear expansion coefficient can be reduced.

Note that, a monomer or an oligomer of benzoxazine, or a resin obtained by being given a high molecular weight by conducting a ring opening polymerization of the oxazine ring of a monomer or an oligomer of benzoxazine, is included in the benzoxazine resin.

To the resin composition, additives such as thermoplastic resins, thermosetting resins other than the epoxy resin, thermoplastic elastomers, crosslinked rubbers, oligomers, inorganic compounds, nucleating agents, antioxidants, antistaling agents, thermostabilizers, light stabilizers, ultraviolet ray absorbing agents, lubricants, flame-retarding auxiliary agents, antistatic agents, anticlouding agents, fillers, softening agents, plasticizing agents, or coloring agents, may be added as necessary. With regard to these additives, a single type may be used by itself, or a combination of two or more types may be used.

Specific examples of the thermoplastic resins include polysulfone resins, polyethersulfone resins, polyimide resins, polyetherimide resins, phenoxy resins, or the like. With regard to the thermoplastic resins, a single type may be used by itself, or a combination of two or more types may be used.

The thermosetting resins include poly vinyl benzyl ether resins, reaction products obtained by reacting a bifunctional polyphenylene ether oligomer and chloromethylstyrene, or the like. With regard to the thermosetting resins, a single type may be used by itself; or a combination of two or more types may be used.

When the thermoplastic resins or the thermosetting resins are used, regarding the contained amount of the thermoplastic resins or the thermosetting resins in 100 parts by weight of the epoxy resin, a preferable lower limit is 0.5 parts by weight, and a more preferable lower limit is 1 part by weight, and a preferable upper limit is 50 parts by weight, and a more preferable upper limit is 20 parts by weight. If the contained amount of the thermoplastic resins or the thermosetting resins is too low, there are cases where the elongation and the toughness of the cured body cannot be increased sufficiently, and if it is too high, there are cases where the strength of the cured body deteriorates.

(Resin Composition)

There is no particular limitation in the method for producing the resin composition. The method for producing the resin composition includes, for example, a method of adding, to a solvent, the epoxy resin, the curing agent, the silica component, and components blended as necessary, drying the mixture, and removing the solvent from the mixture.

The resin composition may be used, for example, after being dissolved in a suitable solvent.

There is no particular limitation in the usage of the resin composition. The resin composition can be suitably used as, for example, a substrate material for forming a core layer, a build-up layer, or the like of a multilayer substrate, an adhesion sheet, a laminated plate, a resin-coated copper foil, a copper clad laminated plate, a TAB tape, a printed-circuit substrate, a prepreg, a varnish, or the like.

Furthermore, by using the resin composition, fine holes can be formed on the surface of the semi-cured body. Therefore, fine wirings can be formed on the surface of the cured body obtained by curing the semi-cured body, and the signal transmission speed of the wirings can be increased. Thus, the resin composition can be suitable for usages requiring insulation characteristics, such as a resin-coated copper foil, a copper clad laminated plate, a printed-circuit substrate, a prepreg, an adhesion sheet, or a TAB tape.

The resin composition is further suitably used in build-up substrates or the like in which cured bodies and conductive plating layers are layered by using the additive process and the semi-additive process to form circuits after forming a conductive plating layer on the surface of the cured body. In such case, the binding strength between the cured bodies and the conductive plating layers can be increased.

The resin composition can also be used as a sealing material, a solder resist, or the like. Furthermore, since high-speed signal transmission performance of the wirings formed on the surface of the cured body can be enhanced, the resin composition can also be used for a parts built-in substrate having built-in passive parts or active parts requiring high frequency characteristics.

(Semi-Cured Body, Cured Body, and Laminated Body)

A semi-cured body is one in which curing is further advanced from a slightly cured state which is generally referred as B state, to a preliminary-cured state suitable for a roughening treatment, in other words, to a semi-cured state.

A reactant can be obtained by reacting the resin composition. The semi-cured body can be obtained by performing a roughening treatment on the obtained reactant.

Specifically, the semi-cured body according to the present invention is obtained as described in the following.

The reactant is obtained by reacting (preliminary-curing or semi-curing) the resin composition so as to obtain a gel fraction equal to or higher than 90% after being immersed in methyl ethyl ketone for 24 hours at 23° C. In order to adequately react the resin composition, the resin composition is reacted preferably by heating, light irradiation, or the like. It is preferable to obtain the reactant by reacting the resin composition so as to obtain a gel fraction equal to or higher than 95%.

When reacting the resin composition so as to obtain a gel fraction equal to or higher than 90% through heating, there is no particular limitation in the heating temperature. The heating temperature is preferably within a range from 130° C. to 190° C. If the heating temperature is lower than 130° C., the gel fraction tends to become low since the resin composition will not be sufficiently cured. As a result, concavities and convexities on the surface of the semi-cured body tend to become large. If the heating temperature is higher than 190° C., the curing reaction of the resin composition tends to progress rapidly. Therefore, the degree of curing tends to differ locally, and as a result, it becomes difficult to obtain uniformity for concavities and convexities on the surface of the semi-cured body.

Although there is no particular limitation in the heating time when reacting the resin composition so as to obtain a gel fraction equal to or higher than 90%, an example of a time range is from 15 minutes to 3 hours. If the heating time is short, the resin composition will not be sufficiently cured, and thereby concavities and convexities on the surface of the semi-cured body after a roughening treatment tend to become large. Therefore, the heating time is preferably equal to or longer than 30 minutes. From the standpoint of increasing productivity, the heating time is preferably equal to or longer than 1 hour.

A roughening treatment is performed on the reactant in order to form fine concavities and convexities on the surface of the semi-cured body. Before the roughening treatment, a swelling treatment is preferably performed on the reactant. However, the swelling treatment may not necessarily be performed on the reactant.

As the method for performing the swelling treatment, for example, a method of treating the reactant by using an aqueous solution or organic solvent dispersed solution of a compound having, as the main component, ethylene glycol or the like may be used. For the swelling treatment, a 40 wt % ethylene glycol aqueous solution is suitably used.

For the roughening treatment, for example, a chemical oxidant such as a manganese compound, a chromium compound, a persulfuric acid compound, or the like can be used. The chemical oxidant is added to water or an organic solvent, and the mixture is used as an aqueous solution or organic solvent dispersed solution.

The manganese compound includes potassium permanganate, sodium permanganate, or the like. The chromium compound includes potassium dichromate, potassium chromate anhydride, or the like. The persulfuric acid compound includes sodium persulfate, potassium persulfate, ammonium persulfate, or the like.

There is no particular limitation in the method for performing a roughening treatment. For the roughening treatment, for example, a permanganic acid or permanganate solution of 30 to 90 g/L, or a sodium hydroxide solution of 30 to 90 g/L may be suitably used.

If the roughening treatment is performed for a large number of times, the roughening effect also becomes large. However, if the number of roughening treatment exceeds three, the roughening effect may reach saturation, or the resin component on the surface of the semi-cured body is removed more than necessary and holes on the surface of the semi-cured body tend not to be formed in the shape obtained by eliminating the silica component. Therefore, the roughening treatment is performed preferably once or twice.

The roughening treatment is performed on the reactant preferably at 50° C. to 80° C. for 5 to 30 minutes. When the swelling treatment is performed on the reactant, the swelling treatment is performed on the reactant preferably at 50° C. to 80° C. for 5 to 30 minutes. When the roughening treatment or the swelling treatment is performed multiple times, the above described time for the roughening treatment or the swelling treatment indicates the total duration of those. As a result of performing, by using the above described conditions, the roughening treatment or the swelling treatment on the reactant reacted so as to obtain a gel fraction equal to or higher than 90%, the surface roughness of the surface of the semi-cured body can be further reduced. Specifically, a semi-cured body having a roughening-treated surface with an arithmetic mean roughness Ra equal to or less than 0.3 μm, and a ten-point mean roughness Rz equal to or less than 3.0 μm can be further easily obtained.

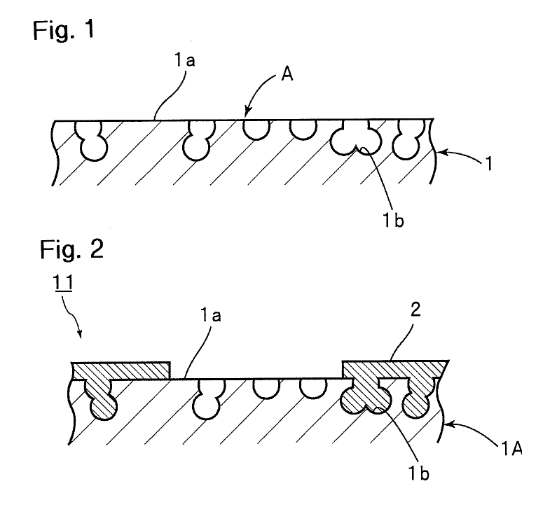

FIG. 1 is a partially-cut front sectional view which schematically shows a semi-cured body according to one embodiment of the present invention.

As shown in FIG. 1, holes 1b, which are formed by eliminating the silica component, are formed on a surface 1a of a semi-cured body 1.

The resin composition has an excellent dispersibility of the silica component, since the silica component obtained by performing a surface treatment on the silica particles by using the silane coupling agent is included. Therefore, large holes resulting from elimination of aggregates of the silica component hardly form on the semi-cured body 1. Thus, the strength of the cured body obtained by curing the semi-cured body 1 or the semi-cured body 1 hardly deteriorates locally, and the adhesive strength between the cured body and the metal layer can be increased. In addition, since the linear expansion coefficient of the cured body is reduced, a large amount of the silica component can be blended in the resin composition. Multiple fine holes 1b can be formed on the surface of the semi-cured body 1 even when a large amount of the silica component is blended. The holes 1b may be holes that result from elimination of a couple of pieces of the silica component, for example, 2 to 10 pieces.

Furthermore, the resin component is not removed more than necessary from a portion shown by arrow A in FIG. 1 in proximity of the holes 1b formed resulting from the elimination of the silica component. In particular, when a compound having a benzoxazine structure, an aromatic multivalent ester compound, or a phenolic compound having a structure of any one of a naphthalene structure, a dicyclopentadiene structure, a biphenyl structure, and an aminotriazine structure, is used as the curing agent, the resin component is easily removed for a relatively large amount from the surfaces of the holes 1b formed resulting for the elimination of the silica component. However, when the silica component obtained by treating the silica particles with the silane coupling agent is used, the resin component will not be removed more than necessary even when a compound having a benzoxazine structure, an aromatic multivalent ester compound, a phenolic compound having a structure of any one of a naphthalene structure, a dicyclopentadiene structure, a biphenyl structure, and an aminotriazine structure is used. Therefore, the strength of the cured body can be increased.

With regard to the surface of the roughening-treated semi-cured body obtained as described above, preferably, the arithmetic mean roughness Ra is equal to or less than 0.3 μm, and the ten-point mean roughness Rz is equal to or less than 3.0 μm. With regard to the roughening-treated surface, the arithmetic mean roughness Ra is more preferably equal to or less than 0.2 μm, and further preferably equal to or less than 0.15 μm. With regard to the roughening-treated surface, the ten-point mean roughness Rz is more preferably equal to or less than 2 μm, and further preferably equal to or less than 1.5 μm. If the arithmetic mean roughness Ra is too large, or if the ten-point mean roughness Rz is too large, an increase in the transmission speed of electric signals through wirings formed on the surface of the cured body may not be achieved. The arithmetic mean roughness Ra and the ten-point mean roughness Rz can be obtained by using measuring methods conforming to JIS B0601-1994.

The plurality of holes formed on the surface of the semi-cured body 1 or the cured body preferably have a mean diameter equal to or smaller than 5 μm. If the mean diameter of the plurality of holes is larger than 5 μm, there will be cases where it becomes difficult to form wirings having a small L/S on the surface of the cured body, and the formed wirings will easily short-circuit.

As necessary, the semi-cured body 1 can be provided with an electrolysis plating, after being treated with a publicly known catalyst for metal plating or being provided with a nonelectrolytic plating. By plate processing the surface of the semi-cured body 1 and by curing the semi-cured body 1, a laminated body 11 including the cured body and a metal layer 2 can be obtained.

FIG. 2 shows a partially-cut front sectional view of the laminated body 11 obtained by forming the metal layer 2 by plate processing the upper surface 1a of a cured body 1A obtained by curing the semi-cured body 1.

As shown in FIG. 2, in the laminated body 11, the metal layer 2 extends into the fine holes 1b formed on the upper surface 1a of the cured body 1A. Therefore, as a result of a physical anchoring effect, the adhesive strength between the cured body 1A and the metal layer 2 can be increased. Furthermore, since the resin component is not removed more than necessary in proximity of the holes 1b formed resulting from the elimination of the silica components, the adhesive strength between the cured body 1A and the metal layer 2 can be increased.

When curing the semi-cured body 1A, the semi-cured body 1A is preferably cured at 130° C. to 200° C. The cured body 1A is preferably a cured body obtained by curing the semi-cured body 1 at 130° C. to 200° C. In such cases, the adhesive strength between the cured body 1A and the metal layer 2 can be further increased.

The smaller the mean particle diameter of the silica component is, finer concavities and convexities can be formed on the surface of the semi-cured body 1. By using the silica component obtained by performing a surface treatment on silica particles having a mean particle diameter of 1 μm using the silane coupling agent, the holes 1b can be reduced in size; and therefore, fine concavities and convexities can be formed on the surface of the semi-cured body 1. Thus, the L/S indicating the degree of fineness of the circuit wirings can be reduced.

When wirings of copper or the like having a small L/S are formed on the surface 1a of the cured body 1A, the signal processing speed of the wirings can be increased. For example, even for signals having a high frequency of 5 GHz or higher, loss of electric signals at an interface between the metal layer 2 and the cured body 1A obtained by curing the semi-cured body 1 can be reduced, since the surface roughness of the surface of the semi-cured body 1 is small.

With the above described resin composition, since included is the silica component obtained by performing a surface treatment using the silane coupling agent on the silica particles having a mean particle diameter equal to or less than 1 μm, fine wirings having a small surface roughness variation and an L/S of, for example, around 13 μm/13 μm can be formed on the surface of the cured body 1A. Furthermore, fine wirings having an L/S of 10 μm/10 μm or less can be formed on the surface of the cured body 1A without resulting in a short circuit between the wirings. The cured body 1A having wirings formed thereon as described above can transmit electric signals stably with small losses.

As a material for forming the metal layer 2, a metallic foil or a metal plating used for shielding or for circuit formation, or a plating material used for circuit protection can be used.

The plating material includes, for example, gold, silver, copper, rhodium, palladium, nickel, tin, or the like. An alloy of two or more types of these may be used. A metal layer having multiple layers may be formed by using two or more types of these plating materials. Furthermore, depending on the purpose, the plating material may include substances or metals other than the above described metals. The metal layer 2 is preferably a copper plating layer formed by copper plate processing.

In the laminated body 11, the adhesive strength between the cured body 1A and the metal layer 2 is preferably equal to or larger than 4.9 N/cm.

The present invention will be described specifically in the following by showing Examples and Comparative Examples. The present invention is not limited to the following Examples.

In the Examples and Comparative Examples, materials shown in the following were used.

(Epoxy Resin)

Biphenyl type epoxy resin (manufactured by Nippon Kayaku Co., Ltd.; product name “NC-3000-H”)

Bisphenol A type epoxy resin (manufactured by Nippon Kayaku Co., Ltd.; product name “RE-310S”)

Anthracene type epoxy resin (manufactured by Japan Epoxy Resins Co., Ltd.; product name “YX8800”)

Naphthalene type epoxy resin (manufactured by Nippon Kayaku Co., Ltd.; product name “NC-7300L”)

Triazine backbone containing epoxy resin (manufactured by Nissan Chemical Industries, Ltd.; product name “TEPIC-SP”)

(Curing Agent)

Phenol curing agent having a biphenyl structure (manufactured by Meiwa Plastic Industries, Ltd.; product name “MEH7851-4H”; corresponding to the phenolic compound represented in formula (7) described above)

Active ester curing agent (active ester compound; manufactured by DIC Corp.; product name “EPICLON EXB9460S-65T”; toluene solution having 65 wt % solid content)

Cyanate ester resin (manufactured by Ronza Group Ltd.; product name “Primaset BA-230S”; methyl ethyl ketone solution having 75 wt % solid content)

(Curing Accelerator)

Imidazole curing accelerator (manufactured by Shikoku Chemicals Corp.; product name “2PN-CN”; 1-cyanoethyl-2-methylimidazole)

(Silica Slurry)

50 wt % silica component containing slurry (I) including 50 wt % of a silica component obtained by performing a surface treatment on silica particles (mean particle diameter 0.3 μm; specific surface area 18 m²/g) by using an amino silane (manufactured by Shin-Etsu Chemical Co., Ltd.; product name “KBM-573) and 50 wt % of DMF (N,N-dimethylformamide)

50 wt % silica component containing slurry (2) including 50 wt % of a silica component obtained by performing a surface treatment on silica particles (mean particle diameter 0.8 μm; specific surface area 4.3 m²/g) by using an amino silane (manufactured by Shin-Etsu Chemical Co., Ltd.; product name “KBM-573”) and 50 wt % of DMF (N,N-dimethylformamide)

(Solvent)

N,N-dimethylformamide (DMF; special grade; manufactured by Wako Pure Chemical Industries, Ltd.)

(Imidazole Silane Compound)

Imidazole silane (manufactured by Nippon Mining & Metals Co., Ltd.; product name “IM-1000”)

### EXAMPLE 1

(1) Preparation of Resin Composition

53.08 g of a slurry containing the silica component for 50 wt % and 7.00 g of DMF were mixed, and agitated at an ordinary temperature until a homogeneous solution was obtained. Then, 0.20 g of the above described imidazole curing accelerator (manufactured by Shikoku Chemicals Corp; product name “2PN-CN”) was further added, and agitated at an ordinary temperature until a homogeneous solution was obtained.

Next, 18.94 g of a bisphenol A type epoxy resin (manufactured by Nippon Kayaku Co., Ltd.; product name “RE-310S”) was added as an epoxy resin, and agitated at an ordinary temperature until it became a homogeneous solution, and thereby a solution was obtained. 20.67 g of a phenol curing agent having a biphenyl structure (manufactured by Meiwa Plastic Industries, Ltd.; product name “MEH7851-4H”) was added to the obtained solution as a curing agent, and agitated at an ordinary temperature until it became a homogeneous solution, and thereby the resin composition was prepared.

(2) Preparation of Un-Cured Object of Resin Composition

A transparent polyethylene terephthalate (PET) film on which release processing was conducted (product name “PET5011 550”; thickness 50 μm; manufactured by LINTEC Corp.) was prepared. The obtained resin composition was applied on this PET film by using an applicator such that its thickness after drying will be 50 μm. Next, the film was dried for 12 minutes at 100° C. inside of a gear oven to prepare a sheet-like un-cured object of the resin composition in a B stage state having a size of length 200 mm×width 200 mm×thickness 50 μm.

(3) Preparation of Semi-Cured Body

The obtained sheet-like un-cured object of the resin composition was vacuum-laminated on a glass epoxy substrate (FR-4; stock number “CS-3665”; manufactured by Risho Kogyo Co., Ltd.), and reacted at 150° C. for 60 minutes (reaction condition). In this manner, the reactant was formed on the glass epoxy substrate, and a lamination sample of the glass epoxy substrate and the reactant was obtained. Next, a swelling treatment described below was performed, and then a roughening treatment (permanganate treatment) described below was performed.

Swelling Treatment:

The lamination sample was placed in an 80° C. swelling liquid (Swelling Dip Securigant P; manufactured by Atotech Japan Co., Ltd.), and oscillated for 15 minutes at a swelling temperature of 80° C. Then, the lamination sample was rinsed with pure water.

Roughening Treatment (Permanganate Treatment):

The lamination sample having the swelling treatment performed thereon was placed in an 80° C. potassium permanganate (Concentrate Compact CP; manufactured by Atotech Japan Co., Ltd.) roughening solution, and oscillated for 15 minutes at a roughening temperature of 80° C. Next, the lamination sample was rinsed for 2 minutes with a 25° C. rinsing liquid (Reduction Securigant P; manufactured by Atotech Japan Co., Ltd.), and further rinsed with pure water. In the manner described above, the roughening-treated semi-cured body was formed on the glass epoxy substrate.

(4) Preparation of Laminated Body

Copper plate processing described below was performed after the above described roughening treatment.

Copper Plate Processing:

By using the following procedure, electroless copper plating and electrolytic copper plating were provided on the semi-cured body formed on the glass epoxy substrate.

The surface of the roughening-treated semi-cured body was delipidated and rinsed by having it treated with a 60° C. alkaline cleaner (Cleaner Securigant 902) for 5 minutes. After rinsing, the semi-cured body was treated with a 25° C. predip liquid (Pre-Dip Neogant B) for 2 minutes. Then, the semi-cured body was treated with a 40° C. activator liquid (Activator Neogant 834) for 5 minutes to be provided with a palladium catalyst. Next, the semi-cured body was treated with a 30° C. reduction liquid (Reducer Neogant WA) for 5 minutes.

Next, the semi-cured body was placed in a chemically copper enriched liquid (Basic Printgant MSK-DK; Copper Printgant MSK; Stabilizer Printgant MSK) to apply a nonelectrolytic plating until the plating thickness was approximately 0.5 μm. After the nonelectrolytic plating, annealing was conducted for 30 minutes at a temperature of 120° C. in order to remove any residual hydrogen gas. All the processes up to the process of nonelectrolytic plating were conducted at a beaker scale with 1 L of processing liquids by oscillating the semi-cured body.

Next, electrolysis plating was applied to the nonelectrolytic plating-processed semi-cured body until the plating thickness was 25 μm. Copper sulfate (Reducer Cu) was used for the electrolytic copper plating, and an electric current of 0.6 A/cm² was passed therethrough. After the copper plating processing, the semi-cured body was heated at 180° C. for 1 hour in order to cure the semi-cured body, and the cured body was formed. In the manner described above, a laminated body having a copper plating layer formed on the cured body was obtained.

### EXAMPLES 2 TO 11, AND COMPARATIVE EXAMPLES 1 TO 5

Resin compositions were prepared, and sheet-like un-cured objects of the resin compositions, semi-cured bodies, and laminated bodies were prepared similarly to Example 1, except for setting the types and blend amounts of used materials as shown in the following Tables 1 and 2, and setting the reaction conditions, which are used when reacting the obtained sheet-like un-cured object of the resin composition to prepare the (3) semi-cured body described above, as shown in the following Tables 1 and 2. Note that, when a resin composition is to include an imidazole silane, the imidazole silane was added together with a curing agent.

(Evaluation)

(Preparation of Cured Body B)

Sheet-like un-cured objects of resin compositions obtained from the Examples and Comparative Examples were heated at 150° C. for 60 minutes, and further heated at 180° C. for 1 hour to be cured, and thereby cured bodies B were obtained.

(1) Gel Fraction

Sheet-like un-cured objects of resin compositions obtained from Examples 1 to 7 and 9 to 11 were reacted at 150° C. for 60 minutes to obtain semi-cured bodies. Furthermore, sheet-like un-cured objects of the resin compositions obtained from Example 8 and Comparative Examples 1 to 4 were reacted at 130° C. for 30 minutes to obtain semi-cured bodies. In addition, a sheet-like un-cured object of a resin composition obtained from Comparative Example 5 was reacted at 120° C. for 30 minutes to obtain a semi-cured body.

The obtained semi-cured bodies were cut so as to have sizes of 50 mm×50 mm, and test samples were prepared. Initial weights (W1) of the test samples were measured. Next, each of the test samples was immersed in methyl ethyl ketone at 23° C. for 24 hours. Then, each of the test samples in methyl ethyl ketone was filtrated by using a #400 metal mesh, which weight was measured in advance, to obtain a residue of each of the test samples on the metal mesh. The residue was dried together with the metal mesh at 23° C. for 72 hours. A weight (W2) of the dried residue was obtained by measuring the total weight of the metal mesh and the dried residue, and dividing the total with the weight of the metal mesh. From the measured value, a gel fraction was calculated by using the following formula (1). An average value of five measurements was used as a gel fraction.

Gel Fraction (%)=W2/W1×100 Formula (1)

(2) Dielectric Constant and Dielectric Loss Tangent

Each of the obtained un-cured objects was cut so as to have a size of 15 mm×15 mm. Eight sheets of each of the cut un-cured objects were layered to obtain a laminate. This laminate was heated at 150° C. for 60 minutes, and further heated at 180° C. for 1 hour to be cured, and thereby a cured body that is a laminate having a thickness of 400 μm was formed. Dielectric constant and dielectric loss tangent of the laminate at frequency of 1 GHz at an ordinary temperature (23° C.) were measured by using a dielectric constant measuring device (stock number “HP4291B”; manufactured by Hewlett-Packard Co.).

(3) Average Linear Expansion Coefficient

The obtained cured bodies B were cut so as to have sizes of 3 mm×25 mm. An average linear expansion coefficient (α1) at 23° C. to 100° C. and an average linear expansion coefficient (α2) at 150° C. to 260° C. of the cut cured bodies were measured by using a linear-expansion-coefficient meter (stock number “TMA/SS120C”; manufactured by Seiko Instruments Inc.) with conditions of tension load of 2.94×10⁻² N and a temperature increase rate of 5° C./minute.

(4) Glass Transition Temperature (Tg)

The obtained cured bodies B were cut so as to have sizes of 5 mm×3 mm. Loss rates tans of the cut cured bodies were measured by using a Viscoelasticity Spectro-Rheometer (stock number “RSA-II”; manufactured by Rheometric Scientific F. E. Ltd.) in a range from 30° C. to 250° C. with a condition of a temperature increase rate of 5° C./minute, and temperatures at which the loss rates tans become maximum values (glass transition temperature Tg) were obtained.

(5) Breaking Strength and Breaking Point Elongation Rate

Each of the obtained cured bodies B was cut so as to have a size of 10×80 mm. Two of each of the cut cured bodies B were laminated and a test sample having a thickness of 100 μm was obtained. A breaking strength (MPa), and a breaking point elongation rate (%) of the test sample were measured by conducting tensile tests using a tensile testing machine (product name “Tensilon”; manufactured by Orientec Co., Ltd.) with a condition of 60 mm distance between chucks and a crosshead speed of 5 mm/minute.

(6) Post-Roughened Adhesive Strength

10-mm width notches were made on the surfaces of the copper plating layers of the laminated bodies obtained by forming the copper plating layers on the cured bodies. Then, adhesive strengths between the copper plating layers and the cured bodies were measured using a tensile testing machine (product name “Autograph”; manufactured by Shimadzu Corp.) with a condition of a crosshead speed of 5 mm/minute, and the obtained measured values were used as post-roughened adhesive strengths.

(7) Surface Roughness (Arithmetic Mean Roughness Ra and Ten-Point Mean Roughness Rz)

Arithmetic mean roughnesses Ra and ten-point mean rougbnesses Rz of the surfaces of the roughening-treated semi-cured bodies were measured by using a non-contact type surface roughness meter (product name “WYKO”; manufactured by Veeco Instruments Inc.),

(8) Copper Adhesive Strength

The sheet-like un-cured objects of resin compositions obtained from the Examples and Comparative Examples were laminated on CZ treated copper foils (CZ-8301; manufactured by MEC Co., Ltd.) inside a vacuum, heated at 150° C. for 60 minutes, further heated at 180° C. for 1 hour to be cured to obtain cured bodies with copper foils. Then, 10-mm width notches were made on the surfaces of the copper foils. Adhesive strengths between copper foils and cured bodies were measured by using a tensile testing machine (product name “Autograph”; manufactured by Shimadzu Corp.) with a condition of a crosshead speed of 5 mm/minute, and the measured adhesive strengths were used as copper adhesive strengths.

(9) Volume Resistivity

The obtained cured bodies B were cut so as to have sizes of 100 mm×100 mm to obtain test samples having 50 μm thicknesses. The obtained test samples were exposed to a PCT condition of 134° C., 3 atm, and 2 hours. After the exposure, volume resistivities of the test samples were measured by connecting a high resistivity meter (manufactured by Mitsubishi Chemical Co., Ltd.; product name “Hiresta UP”) to a U-type J-Box.

The results are shown in the following Tables 1 and 2.

TABLE 1

| | | | Example 1 | Example 2 | Example 3 | Example 4 |
|---|---|---|---|---|---|---|
| Blend Component (g) | Epoxy Resin | Biphenyl Type Epoxy Resin | | 9.06 | | |
| | | Bisphenol A Type Epoxy Resin | 18.94 | 11.58 | 11.10 | 11.50 |
| | | Anthracene Type Epoxy Resin | | | 7.75 | |
| | | Naphthalene Type Epoxy Resin | | | | 8.03 |
| | | Triazine Backbone Containing | | | | |
| | | Epoxy Resin | | | | |
| | Curing Agent | Phenol Curing Agent Having | 20.67 | 18.96 | 20.76 | 20.09 |
| | | Biphenyl Structure | | | | |
| | | Active Ester Compound | | | | |
| | | Cyanate Ester Resin | | | | |
| | Curing Accelerator | Imidazole Curing Accelerator | 0.20 | 0.20 | 0.20 | 0.20 |
| | Silica Slurry | 50 wt % Silica Component | 53.08 | 53.08 | 53.08 | 53.08 |
| | | Containing Slurry (1) | | | | |
| | | 50 wt % Silica Component | | | | |
| | | Containing Slurry (2) | | | | |
| | Solvent | N,N-dimethylformamide | 7.00 | 7.00 | 7.00 | 7.00 |
| | Imidazole Silane Compound | Imidazole Silane | | | | |
| Reaction Condition | | | 150° C. × | 150° C. × | 150° C. × | 150° C. × |
| | | | 60 min. | 60 min. | 60 min. | 60 min. |
| Evaluation | (1) Gel Fraction | (%) | 100 | 100 | 100 | 100 |
| | (2) Electrical Properties (1 GHz) | Dielectric Constant | 3.3 | 3.2 | 3.4 | 3.3 |
| | | Dielectric Loss Tangent | 0.017 | 0.012 | 0.018 | 0.017 |
| | (3) Average Linear Expansion Coefficient | a1 (×10⁵/° C.) | 39 | 36 | 32 | 35 |
| | | a2 (×10⁵/° C.) | 141 | 132 | 122 | 130 |
| | (4) Glass Transition Temperature (Tg) | (° C.) | 170 | 178 | 183 | 186 |
| | (5) Breaking Strength | (MPa) | 87 | 95 | 86 | 90 |
| | (5) Breaking Point Elongation Rate | (%) | 4.4 | 5.6 | 4.0 | 5.8 |
| | (6) Post-Roughened Adhesive Strength | (N/cm) | 8.8 | 9.8 | 8.8 | 8.8 |
| | (7) Surface Roughness | Arithmetic Mean Roughness Ra | 0.07 | 0.05 | 0.08 | 0.08 |
| | | (μm) | | | | |
| | | Ten-Point Mean Roughness Rz | 0.84 | 0.65 | 0.90 | 0.95 |
| | | (μm) | | | | |
| | (8) Copper Adhesive Strength | (N/cm) | 9.8 | 9.8 | 8.8 | 8.8 |
| | (9) Volume Resistivity | (×10¹⁴ Ω · cm) | 56 | 64 | 54 | 47 |

| | | | Comparative | Comparative | Comparative | Comparative |
|---|---|---|---|---|---|---|
| | | | Example 1 | Example 2 | Example 3 | Example 4 |
| Blend | Epoxy Resin | Biphenyl Type Epoxy Resin | | 9.06 | | |
| Component (g) | | Bisphenol A Type Epoxy Resin | 18.94 | 11.58 | 11.10 | 11.50 |
| | | Anthracene Type Epoxy Resin | | | 7.75 | |
| | | Naphthalene Type Epoxy Resin | | | | 8.03 |
| | | Triazine Backbone Containing | | | | |
| | | Epoxy Resin | | | | |
| | Curing Agent | Phenol Curing Agent Having | 20.67 | 18.96 | 20.76 | 20.09 |
| | | Biphenyl Structure | | | | |
| | | Active Ester Compound | | | | |
| | | Cyanate Ester Resin | | | | |
| | Curing Accelerator | Imidazole Curing Accelerator | 0.20 | 0.20 | 0.20 | 0.20 |
| | Silica Slurry | 50 wt % Silica Component | 53.08 | 53.08 | 53.08 | 53.08 |
| | | Containing Slurry (1) | | | | |
| | | 50 wt % Silica Component | | | | |
| | | Containing Slurry (2) | | | | |
| | Solvent | N,N-dimethylformamide | 7.00 | 7.00 | 7.00 | 7.00 |
| | Imidazole Silane Compound | Imidazole Silane | | | | |
| Reaction Condition | | | 130° C. × | 130° C. × | 130° C. × | 130° C. × |
| | | | 30 min. | 30 min. | 30 min. | 30 min. |
| Evaluation | (1) Gel Fraction | (%) | 85 | 88 | 80 | 86 |
| | (2) Electrical Properties (1 GHz) | Dielectric Constant | 3.3 | 3.2 | 3.4 | 3.3 |
| | | Dielectric Loss Tangent | 0.017 | 0.012 | 0.018 | 0.017 |
| | (3) Average Linear Expansion Coefficient | a1 (×10⁵/° C.) | 39 | 36 | 32 | 35 |
| | | a2 (×10⁵/° C.) | 141 | 132 | 122 | 130 |
| | (4) Glass Transition Temperature (Tg) | (° C.) | 170 | 178 | 183 | 186 |
| | (5) Breaking Strength | (MPa) | 87 | 95 | 86 | 90 |
| | (5) Breaking Point Elongation Rate | (%) | 4.4 | 5.6 | 4.0 | 5.8 |
| | (6) Post-Roughened Adhesive Strength | (N/cm) | 2.0 | 2.0 | 1.0 | 2.0 |
| | (7) Surface Roughness | Arithmetic Mean Roughness Ra | 0.42 | 0.38 | 0.48 | 0.44 |
| | | (μm) | | | | |
| | | Ten-Point Mean Roughness Rz | 4.35 | 3.95 | 5.02 | 4.57 |
| | | (μm) | | | | |
| | (8) Copper Adhesive Strength | (N/cm) | 9.8 | 9.8 | 8.8 | 8.8 |
| | (9) Volume Resistivity | (×10¹⁴ Ω · cm) | 56 | 64 | 54 | 47 |

TABLE 2

| | | | Example 5 | Example 6 | Example 7 | Example 8 |
|---|---|---|---|---|---|---|
| Blend Component (g) | Epoxy Resin | Biphenyl Type Epoxy Resin | | | | 21.57 |
| | | Bisphenol A Type Epoxy Resin | 14.74 | 19.70 | 14.51 | |
| | | Anthracene Type Epoxy Resin | | | | |
| | | Naphthalene Type Epoxy Resin | | | | |
| | | Triazine Backbone Containing | 2.44 | | | |
| | | Epoxy Resin | | | | |
| | Curing Agent | Phenol Curing Agent Having | 22.43 | | 15.84 | 18.05 |
| | | Biphenyl Structure | | | | |
| | | Active Ester Compound | | 19.91 | | |
| | | Cyanate Ester Resin | | | 12.36 | |
| | Curing Accelerator | Imidazole Curing Accelerator | 0.20 | 0.20 | 0.20 | 0.20 |
| | Silica Slurry | 50 wt % Silica Component | 53.08 | 53.08 | 53.08 | 53.08 |
| | | Containing Slurry (1) | | | | |
| | | 50 wt % Silica Component | | | | |
| | | Containing Slurry (2) | | | | |
| | Solvent | N,N-dimethylformamide | 7.00 | 7.00 | 3.91 | 7.00 |
| | Imidazole Silane Compound | Imidazole Silane | | | | |
| Reaction Condition | | | 150° C. × | 150° C. × | 150° C. × | 130° C. × |
| | | | 60 min. | 60 min. | 60 min. | 30 min. |
| Evaluation | (1) Gel Fraction | (%) | 98 | 100 | 100 | 95 |
| | (2) Electrical Properties (1 GHz) | Dielectric Constant | 3.4 | 3.1 | 3.2 | 32 |
| | | Dielectric Loss Tangent | 0.019 | 0.006 | 0.012 | 0.012 |
| | (3) Average Linear Expansion Coefficient | a1 (×10⁵/° C.) | 32 | 34 | 29 | 34 |
| | | a2 (×10⁵/° C.) | 120 | 135 | 116 | 130 |
| | (4) Glass Transition Temperature (Tg) | (° C.) | 193 | 160 | 190 | 180 |
| | (5) Breaking Strength | (MPa) | 83 | 92 | 100 | 92 |
| | (5) Breaking Point Elongation Rate | (%) | 4.0 | 4.1 | 4.5 | 5.8 |
| | (6) Post-Roughened Adhesive Strength | (N/cm) | 7.8 | 7.8 | 8.8 | 6.9 |
| | (7) Surface Roughness | Arithmetic Mean Roughness Ra | 0.14 | 0.06 | 0.19 | 0.20 |
| | | (μm) | | | | |
| | | Ten-Point Mean Roughness Rz | 1.56 | 0.74 | 2.02 | 2.24 |
| | | (μm) | | | | |
| | (8) Copper Adhesive Strength | (N/cm) | 9.8 | 9.8 | 8.8 | 8.8 |
| | (9) Volume Resistivity | (×10¹⁴ Ω · cm) | 46 | 49 | 50 | 74 |

| | | | | Example | Example | Comparative |
|---|---|---|---|---|---|---|
| | | | Example 9 | 10 | 11 | Example 5 |
| Blend Component (g) | Epoxy Resin | Biphenyl Type Epoxy Resin | | | | |
| | | Bisphenol A Type Epoxy Resin | 14.74 | 19.70 | 18.94 | 18.94 |
| | | Anthracene Type Epoxy Resin | | | | |
| | | Naphthalene Type Epoxy Resin | | | | |
| | | Triazine Backbone Containing | 2.44 | | | |
| | | Epoxy Resin | | | | |
| | Curing Agent | Phenol Curing Agent Having | 22.43 | | 20.67 | 20.67 |
| | | Biphenyl Structure | | | | |
| | | Active Ester Compound | | 19.91 | | |
| | | Cyanate Ester Resin | | | | |
| | Curing Accelerator | Imidazole Curing Accelerator | 0.20 | 0.20 | 0.20 | 0.20 |
| | Silica Slurry | 50 wt % Silica Component | 53.08 | 53.08 | | 53.08 |
| | | Containing Slurry (1) | | | | |
| | | 50 wt % Silica Component | | | 53.08 | |
| | | Containing Slurry (2) | | | | |
| | Solvent | N,N-dimethylformamide | 7.00 | 7.00 | 7.00 | 7.00 |
| | Imidazole Silane Compound | Imidazole Silane | 0.15 | 0.15 | | |
| Reaction Condition | | | 150° C. × | 150° C. × | 150° C. × | 120° C. × |
| | | | 60 min. | 60 min. | 60 min. | 30 min. |
| Evaluation | (1) Gel Fraction | (%) | 100 | 100 | 100 | 69 |
| | (2) Electrical Properties (1 GHz) | Dielectric Constant | 3.4 | 3.1 | 3.3 | 3.3 |
| | | Dielectric Loss Tangent | 0.020 | 0.006 | 0.017 | 0.017 |
| | (3) Average Linear Expansion Coefficient | a1 (×10⁵/° C.) | 31 | 33 | 38 | 39 |
| | | a2 (×10⁵/° C.) | 117 | 132 | 138 | 141 |
| | (4) Glass Transition Temperature (Tg) | (° C.) | 200 | 168 | 171 | 170 |
| | (5) Breaking Strength | (MPa) | 87 | 95 | 90 | 87 |
| | (5) Breaking Point Elongation Rate | (%) | 3.9 | 3.9 | 4.8 | 4.4 |
| | (6) Post-Roughened Adhesive Strength | (N/cm) | 9.8 | 9.8 | 4.9 | 2.0 |
| | (7) Surface Roughness | Arithmetic Mean Roughness Ra | 0.08 | 0.05 | 0.05 | 0.56 |
| | | (μm) | | | | |
| | | Ten-Point Mean Roughness Rz | 0.94 | 0.62 | 0.56 | 5.84 |
| | | (μm) | | | | |
| | (8) Copper Adhesive Strength | (N/cm) | 7.8 | 8.8 | 9.2 | 8.8 |
| | (9) Volume Resistivity | (×10¹⁴ Ω · cm) | 52 | 54 | 80 | 56 |

### DESCRIPTION OF THE REFERENCE CHARACTERS

1 . . . semi-cured body

1a . . . upper surface

1b . . . hole

1A . . . cured body

2 . . . metal layer

11 . . . laminated body

1. A semi-cured body formed by having a roughening treatment performed on a reactant obtained through a reaction of a resin composition which includes an epoxy resin, a curing agent, and a silica component in which silica particles with a mean particle diameter equal to or less than 1 μm are surface treated with a silane coupling agent, excluding imidazole silanes, the reaction being performed such that the reactant has a gel fraction equal to or higher than 95% after being immersed in methyl ethyl ketone for 24 hours at 23° C.;
the silane coupling agent includes at least one selected from the group consisting of epoxy silanes, amino silanes, isocyanate silanes, acryloxy silanes, methacryloxy silanes, vinyl silanes, styryl silanes, ureido silanes, and sulfide silanes;
a surface, on which the roughening treatment is performed, having an arithmetic mean roughness Ra equal to or less than 0.3 μm and a ten-point mean roughness Rz equal to or less than 3.0 μm.

2. (canceled)

3. (canceled)

4. The semi-cured body according to claim 1, wherein the epoxy resin is at least one type selected from the group consisting of epoxy resins having a naphthalene structure, epoxy resins having a dicyclopentadiene structure, epoxy resins having a biphenyl structure, epoxy resins having an anthracene structure, epoxy resins having a bisphenol-A structure, and epoxy resins having a bisphenol-F structure.

5. The semi-cured body according to claim 1, wherein the curing agent is at least one type selected from the group consisting of phenolic compounds having a naphthalene structure, phenolic compounds having a dicyclopentadiene structure, phenolic compounds having a biphenyl structure, phenolic compounds having an aminotriazine structure, active ester compounds, and cyanate resins.

6. The semi-cured body according to claim 1, wherein the resin composition further includes an imidazole silane compound within a range from 0.01 to 3 parts by weight with regard to a total 100 parts by weight of the epoxy resin and the curing agent.

7. The semi-cured body according to claim 1, wherein the roughening treatment is performed on the reactant at 50° C. to 80° C. for 5 to 30 minutes.

8. The semi-cured body according to claim 7, wherein a swelling treatment is performed on the reactant before the roughening treatment.

9. The semi-cured body according to claim 8, wherein the swelling treatment is performed on the reactant at 50° C. to 80° C. for 5 to 30 minutes.

10. A cured body obtained by having the semi-cured body, according to claim 1, cured.

11. The cured body according to claim 10 obtained by having the semi-cured body cured at 130° C. to 200° C.

12. A laminated body comprising the cured body according to claim 10, and a metal layer formed by having a plate processing performed on the surface of the cured body, an adhesive strength between the cured body and the metal layer being equal to or larger than 4.9 N/cm.

13. A method for producing the semi-cured body according to claim 1, the method comprising:
forming a reactant through a reaction of the resin composition which includes an epoxy resin, a curing agent, and a silica component in which silica particles with a mean particle diameter equal to or less than 1 μm are surface treated with a silane coupling agent, excluding imidazole silanes, the reaction being performed such that the reactant has a gel fraction equal to or higher than 95% after being immersed in methyl ethyl ketone for 24 hours at 23° C.; and
forming, by having a roughening treatment performed on the reactant, a semi-cured body with a surface, on which the roughening treatment is performed, having an arithmetic mean roughness Ra equal to or less than 0.3 μm and a ten-point mean roughness Rz equal to or less than 3.0 μm, wherein
the silane coupling agent includes at least one selected from the group consisting of epoxy silanes, amino silanes, isocyanate silanes, acryloxy silanes, methacryloxy silanes, vinyl silanes, styryl silanes, ureido silanes, and sulfide silanes.

14. The method for producing the semi-cured body according to claim 13, wherein the method further comprises performing a swelling treatment on the reactant before the roughening treatment.

15. A method for producing the cured body comprising curing, at 130° C. to 200° C., the semi-cured body obtained by the method for producing the semi-cured body according to claim 13.

16. The semi-cured body according to claim 1, wherein the curing agent includes at least one selected from the group consisting of phenolic compounds, active ester compounds, and cyanate resins.

17. The semi-cured body according to claim 1, wherein the resin composition further includes an imidazole curing accelerator.
